(19) United States
(12) Patent Application Publication
(10) Pub. No.: US 2006/0181377 A1
(43) Pub. Date: Aug. 17, 2006

(54) Switch pad and micro-switch having the same

(75) Inventors: Soon-cheol Kweon, Seoul (KR); Hyung-jae Shin, Seongnam-si (KR); Che-heung Kim, Yougin-si (KR); Sang-hun Lee, Seoul (KR); Mark Da Silva, Scituate, MA (US); Siebe Bouwstra, Schoorl (NL)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/345,379

(22) Filed: Feb. 2, 2006

(30) Foreign Application Priority Data
Feb. 17, 2005 (KR) 10-2005-0013182

(51) Int. Cl. H01H 51/22

(52) U.S. Cl. 335/78

(57) ABSTRACT

A switch pad for switching signal flow and a micro-switch having the same. The switch pad comprises a body formed so that as approaching opposite end portions from a central portion of the body, the body is more remotely spaced from a horizontal plane containing a top surface of the electrostatic driving unit. With the body of the switch pad formed in this manner, the switch pad can be more stably driven.

### CROSS-REFERENCE TO RELATED APPLICATIONS

This application claims the benefit of Korean Patent Application No. 2005-13182, field on Feb. 17, 2005, in the Korean Intellectual Property Office, the disclosure of which is incorporated herein by reference.

### BACKGROUND OF THE INVENTION

1. Field of the Invention

The present invention relates to a micro-switch, such as an RF (Radio Frequency) switch, which is driven by an electrostatic force, and in particular to a switch pad for switching signal flow and a micro-switch having the same.

2. Description of the Related Art

In general, a micro-switch, such as an RF switch, which is configured using a MEMS technique, includes a switch pad, which comes into contact with or moves away from a signal line, thereby switching signal flow. Such a switch pad is supported by a spring and driven by an electrostatic driving unit, to which a driving voltage is applied, so that the switch pad comes into contact with or moves away from a signal line.

FIG. 1 schematically shows an example of a representative RF switch.

The RF switch 1 includes a switch pad 16, which comes into contact with or moves away from signal lines 32, 33 to switch signal flow, an electrostatic driving unit 12 for driving the switch pad 16, and a spring structure 10 for elastically supporting the switch pad.

The switch pad 16 is formed from a multi-layered film having a metallic layer 28 and first and second insulation layers 27, 29, such as silicon nitride films, deposited on the top and bottom sides of the metallic layer 28, wherein the switch pad 16 has first and second terminal connection units 30a, 30b, which are formed on the bottom side of the opposite ends 16a, 16b of the switch pad 16, so that they come into contact with or move away from first and second switching terminals 32a, 32b (see FIG. 2A); 33a, 33b, to pass or block signal flow.

The electrostatic driving unit 12 is formed on a substrate 11 between first and second signal lines 32, 33, wherein the electrostatic driving unit 12 consists of first and second driving electrodes 13, 14 formed from a conductive metallic material.

The spring structure 10 comprises first and second support posts 21a, 21b, and first and second springs 22, 23.

The first and second support posts 21a, 22b are mounted on a ground 15 formed on the substrate 11 adjacent to the rear edge 16c and the front edge 16d of the switch pad 16, respectively, and vertically projected. Like the switch pad 16, the upper parts 21a′, 21b′ of the first and second support posts 21a, 21b are formed from a multi-layered film having a metallic layer 28 and first and second insulation layers 27, 29, such as silicon nitride films, deposited on the top and bottom surfaces.

The first and second springs 22a, 23a are interposed between the rear and front edges 16c, 16b of the switch pad 16 and the upper parts 21a′, 22b′ of the first and second support posts 21a, 22b. The first and second springs 22a, 23a are formed from the same metallic material as the metallic layers 28 of the switch pad 16 and the upper parts 21a′, 21b′ of the first and second support posts 21a, 21b.

Such a conventional RF switch 1 shall be manufactured, so that the distance d between the switch pad 16 and the first and second driving electrodes 13, 14 is retained in a predetermined level or more in the initial stage, as shown in FIG. 2A, so as to prevent the first and second terminal connection units 30a, 30b from coming into contact with the first and second switching terminals 32a, 32b; 33a, 33b when no driving voltage is applied to the first and second electrodes 13, 14, because the switch pad 16 is formed in a straight flat shape and the first and second terminal connection units 30a, 30b, which are adapted to come into contact with or move away from the first and second switching terminals 32a, 32b; 33a, 33b are formed on the bottom side of the opposite ends 16a, 16b of the switch pad 16.

When a driving voltage is applied to the first and second driving electrodes 13, 14, for example, to the second driving electrode 14 as shown in FIG. 2B, the electrostatic force generated between the switch pad 16 and the second driving electrode 14 is reduced if the distance d between the switch pad 16 and the first and second driving electrodes 13, 14 exceeds a predetermined range as described above. As a result, the switch pad 16 cannot be stably driven against the rotational torsional rigidity of the first and second springs 22, 23. Therefore, in order to make the switch pad 16 driven stably, it is necessary to increase the driving voltage applied to the first and second driving electrodes 13, 14 or to reduce the rotational torsional rigidity of the first and second springs 22, 23.

However, if the driving voltage applied to the first and second driving electrodes 13, 14 is increased, the power consumption will be also increased. Furthermore, such a measurement cannot be employed in a system or module, which requires an RF switch driven by a low driving voltage, such as a cordless communication system, an antenna tuner, a transceiver, and a phased array antenna.

If the rotational torsional rigidity of the first and second springs 22, 23 is reduced, the strength of the first and second springs 22, 23 for respectively retaining the first and second terminal connection units 30a, 30b not to come into contact with the first and second switching terminals 32a, 33a; 32b, 33b in the state in which the driving voltage is not applied to the first and second driving electrodes 13, 14 is weakened, whereby there arises a problem in that the RF switch 1 becomes too sensitive to a vibration environment.

### SUMMARY OF THE INVENTION

The present invention provides a switch pad which can be stably driven even by a low driving voltage, and a micro-switch employing the same.

According to an aspect of the present invention there is provided a switch pad for a micro-switch, which comes into contact with or moves away from the signal line to switch signal flow, wherein the switch pad comprises a body having a central portion supported above the substrate and formed so that as approaching opposite end portions from the central portion of the body, the body is more remotely spaced from a horizontal plane containing a top surface of the electrostatic driving unit.

According to another aspect of the invention, the body is formed in a step-like shape. Alternatively, the body may be formed in a curved shape.

According to another aspect of the present invention, there is provided a micro-switch comprising: a substrate; at least one signal line provided on the substrate; at least one electrostatic driving unit provided on the substrate; a switch pad, which comes into contact with or moves away from a signal line to switch signal flow, wherein the switch pad comprises a body formed so that as approaching opposite end portions from a central portion of the body, the body becomes more remotely spaced from a horizontal plane containing a surface of the electrostatic driving unit; and a spring structure for pivotally supporting the switch pad at a central portion thereof above the substrate.

According to another aspect of the invention, the body of the switch pad is formed in a step-like shape. Alternatively, the body may be formed in a curved shape.

### BRIEF DESCRIPTION OF THE DRAWINGS

The above aspects and features of the present invention will be more apparent from the description for certain exemplary embodiments of the present invention taken with reference to the accompanying drawings, in which:

FIG. 1 a schematic perspective view of a conventional RF switch;

FIGS. 2A and 2B are cross-sectional views taken along line I-I of FIG. 1;

FIGS. 3A and 3B are conceptional views for describing the principle of an exemplary embodiment of the present invention;

FIG. 4 is a schematic perspective view of an RF switch employing an exemplary embodiment of the inventive switch pad;

FIGS. 5A and 5B are cross-sectional views taken along line II-II of FIG. 4; and

FIGS. 6A and 6B are cross-sectional view of an RF switch employing a variant of an exemplary embodiment of the inventive switch pad taken along the position corresponding to line II-II of FIG. 4.

### DETAILED DESCRIPTION OF THE ILLUSTRATIVE, NON-LIMITING EMBODIMENTS OF THE INVENTION

Hereinbelow, exemplary embodiments of the present invention are described in detail with reference to accompanying drawings.

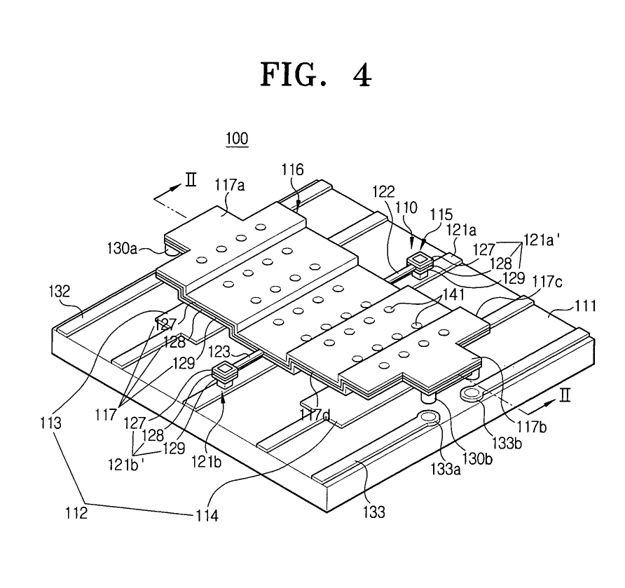

FIG. 4 shows a micro-switch employing a switch pad according to an exemplary embodiment of the present invention.

The micro-switch employing the exemplary embodiment switch pad is an RF switch 100 for switching signal flow.

The RF switch 100 comprises a substrate 111, first and second signal lines 132, 133, an electrostatic driving unit 112, a switch pad 116, and a spring structure 110.

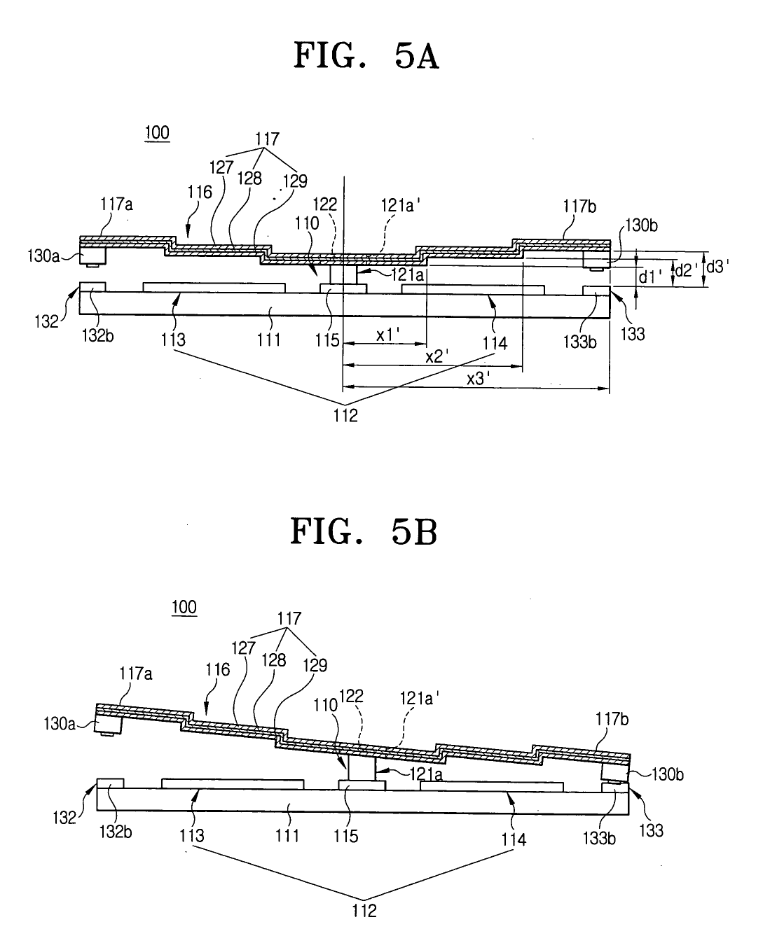

The first and second signal lines 132, 133 are formed from a conductive metallic material such as gold (Au), silver (Ag) or the like and are provided on the left and right halves of the top surface of the substrate 111. Each of the first and second signal lines 132, 133 include first and second switching terminals 132b (only one is shown in FIGS. 5A and 5B); 133a, 133b, wherein first and second terminal connection units 130a, 130b come into contact with or move away from the first and second switching terminals 132b; 133a, 133b.

The electrostatic driving unit 112 comprises first and second driving electrodes 113, 114 formed on the substrate 111 between the first and second signal lines 132, 133. The first and second driving electrodes 113, 114 are formed from a metallic material, such as gold (Ag) or silver (Au), or the like, that has a good conductivity.

The switch pad 116 comes into contact with or moves away from the first and second switching terminals 132b; 133a, 133b of the first and second signal lines 132, 133, thereby switching signal flow, in which the switch pad 116 comprises a body 117 which is elastically supported above the substrate 111 by the first and second springs 122, 123 of the spring structure 110.

The body 117 of the switch pad 116 is formed from a multi-layered film having a metallic layer 128 formed from a metallic material such as aluminum (Al), and first and second insulation layers 127, 129, such as silicon nitride film or the like, deposited on the top and bottom sides of the metallic layer 128.

The body 117 of the switch pad 116 has first and second terminal connection units 130a, 130b in a shape of an upside down “U” formed on the bottom side of first and second ends 117a, 117b thereof, respectively. The first and second terminal connection units 130a, 130b come into contact with or move away from first and second switching terminals 132a; 133a, 133b to interconnect or cut off the first and second switching terminals 132a; 133a, 133b, wherein the first and second terminal connection units 130a, 130b are formed from a metallic material, such as gold (Au), silver (Ag) or the like, that has a good conductivity.

The body 117 of the switch pad 116 is formed, so that as approaching opposite end portions from the central portion of the body supported by the first and second springs 122, 123, the body 117 is more remotely spaced from a horizontal plane containing a top surface of the first and second driving electrodes 113, 114, in order to assure that the switch pad 116 can be stably driven even if a low driving voltage is applied to the first and second driving electrodes 113, 114.

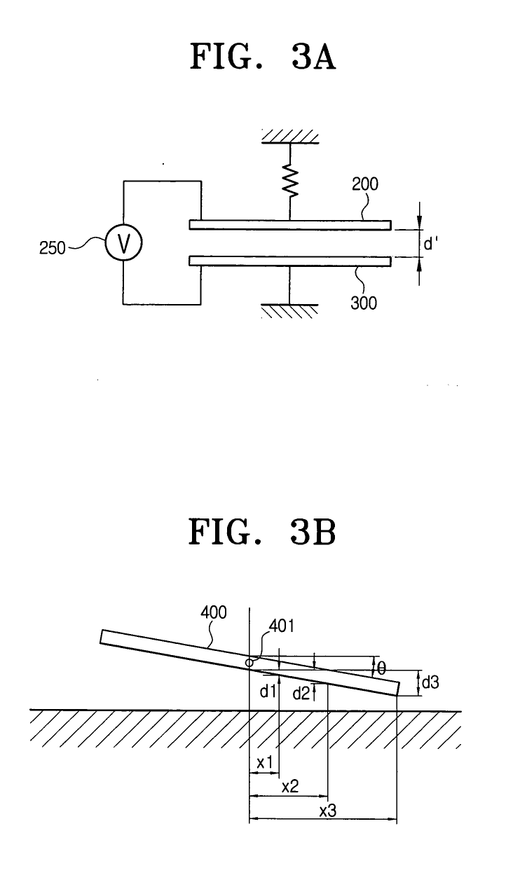

More specifically, the electrostatic force Fe generated between two electrodes 200, 300 having potential difference as shown in FIG. 3A is proportional to a dielectric constant (ε₀=8.85×10⁻¹² F/m; dielectric constant in the air), the sectional area A of the two electrodes, and the square of a driving voltage V supplied from a power supply 250, and inversely proportional to the square of the distance d′ between the two electrodes 200, 300, as indicated by the equation below:

$$Fe = \frac{1}{2} {{ɛ}_{0} ( \frac{V}{{d}^{′}} )}^{2} A$$

Therefore, under the condition that the sectional area A of the two electrodes 200, 300 is constant, the electrostatic force will be reduced if the distance d′ between the two electrodes 200, 300 is increased. In addition, when as shown in FIG. 3B, a structure 400 pivoting about a rotational axis 401 is pivoted to an angle θ, the displacements d1, d2, d3 of the structure 400 at given points are increased proportional to the distances x1, x2, x3 from the rotational axis 401.

Accordingly, if the distances d1′, d2′, d3′ between the body 117 and the horizontal plane containing the top surfaces of the first and second driving electrodes 113, 114 at the initial stage are increased proportional to the distances x1′, x2′, x3′ from the central portion supported by the first and second springs 122, 123, as shown in FIG. 5A, it is possible to maximize the effect of the electrostatic force exerted between the body 117 and the first and second driving electrodes 113, 114 while preventing the first and second terminal connection units 130a, 130b from coming into contact with the first and second switching terminals 132b; 133a, 133b, respectively, when no driving voltage is applied to the first and second driving electrodes 113, 114.

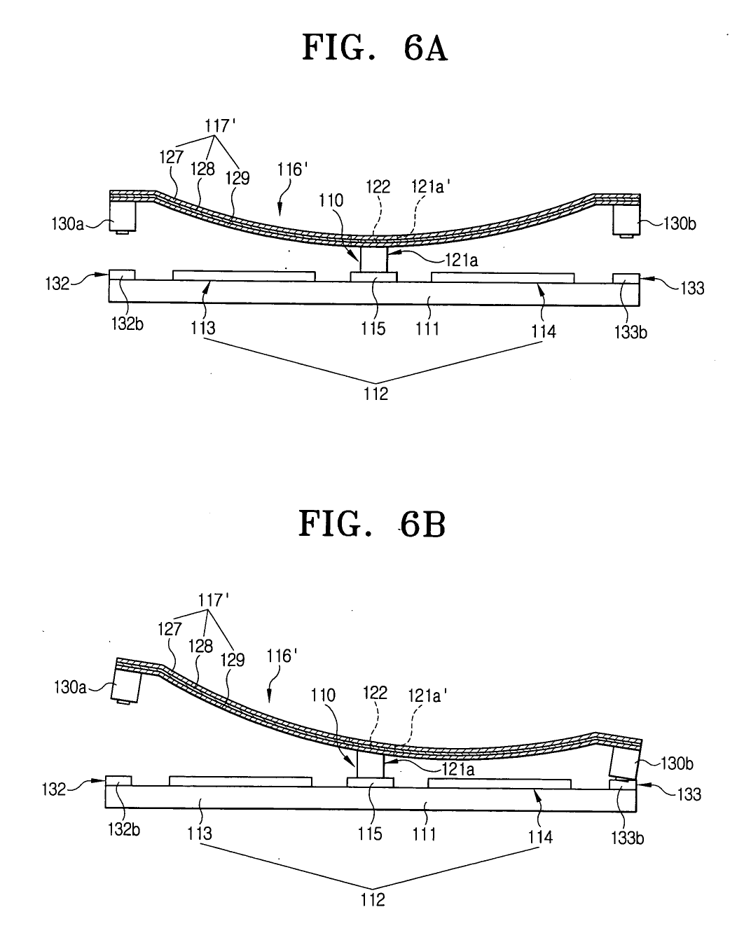

Therefore, in the present exemplary embodiment, the body 117 is formed in a step-like shape, so that as approaching the opposite end portions from the central portion of the body, the distance between the body 117 and the horizontal plane containing the top surfaces of the first and second electrodes 113, 114 is increased as indicated by d1′, d2′, d3′. However, the shape of the body is not limited to a step-like shape. For example, the body 117′ of the switch pad 116′ can be formed in a curved shape as shown in FIGS. 6A and 6B, so that the distance between the body 117′ and the plane containing the top surfaces of the first and second driving electrodes 113, 114 is increased as approaching the opposite end portions from the central portion of the body 117′ supported by the first and second springs 122, 123.

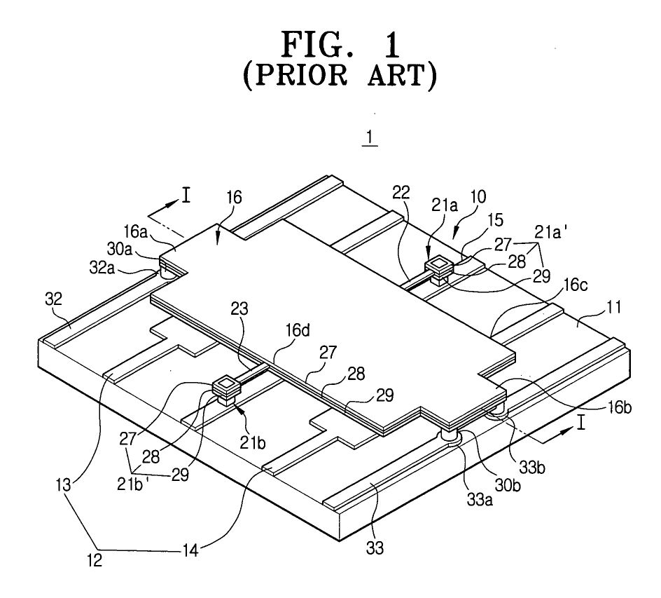

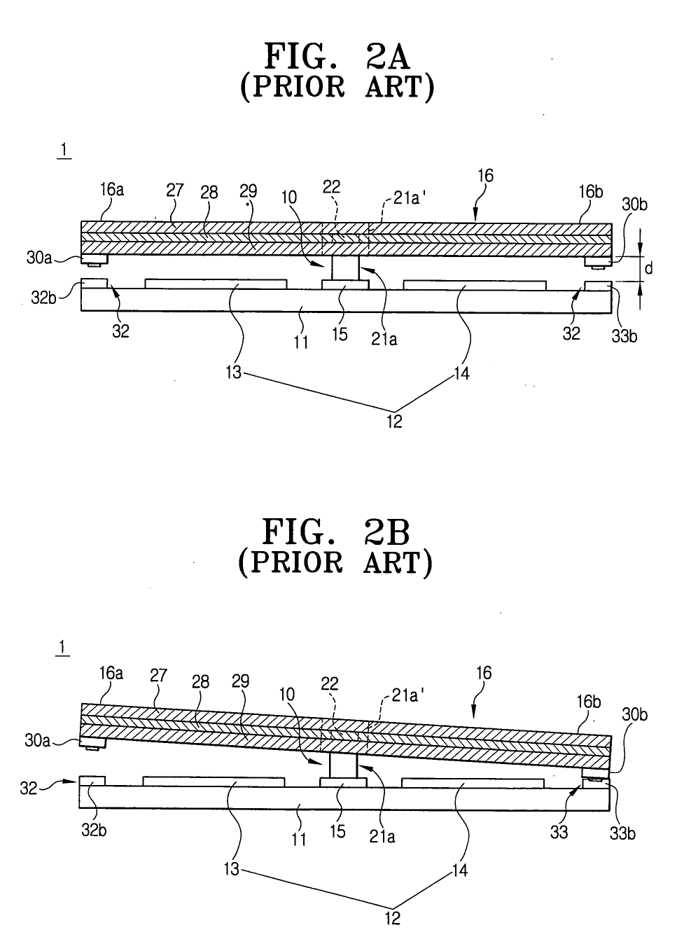

If the body 117 is formed so that as approaching the opposite end portions from the central portion of the body 117, the body 117 is more remotely spaced from a horizontal plane containing the top surfaces of the first and second driving electrodes 113, 114 as described above, it is possible to substantially reduce the driving voltage applied to the first and second driving electrodes 113, 114 as compared with the conventional RF switch 1 (shown in FIGS. 1 to 2B) fabricated in the same condition with the exemplary embodiments of the inventive RF switch but entirely having a constant distance d between the switch pad 16 and the horizontal plane containing the top surfaces the first and second driving electrodes 13, 14 which is same with the distance d3′ between the opposite end portions of the body 117 and the top surfaces of the first and second driving electrodes 113, 114.

In addition, even if a driving voltage equal to or lower than that applied to the first and second driving electrodes 13, 14 of the conventional RF switch 1 by a predetermined range is applied to the first and second driving electrodes 113, 114, the electrostatic force generated between the body 117 and the first and second driving electrodes 113, 114 is higher than that to be generated in the conventional RF switch 1. Therefore, it is not necessary to reduce the rotational torsional rigidity of the first and second springs 122, 123 in order to stably driving the body 117. Furthermore, because it is unnecessary to reduce the rotational torsional rigidity of the first and second springs 122, 123, it is also possible to avoid the problem that the switch pad becomes too sensitive to the vibration environment due to the reduction of rotational torsional rigidity of the first and second springs 122, 123 for retaining the first and second terminal connection units 130a, 130b not to come into contact with the first and second switching terminals 132b; 133a, 133b.

The body 117 of the switch pad 116 may have a plurality of etching holes 141 so as to facilitate an etching process for forming the first and second signal lines 132, 133, and the first and second electrodes 113, 114 or the like underneath the switch pad 116 at the time of manufacturing the micro-switch.

The spring structure 110 elastically supports the switch pad 116 in such a manner that the switch pad 116 can float above the substrate 111, wherein the spring structure 110 comprises first and second support posts 121a, 121b, and first and second springs 122, 123.

The first and second support posts 121a, 121b are provided on a ground 115 formed on the substrate adjacent to the rear edge 117c and the front edge 117d of the body 117, respectively, and vertically projected from the ground.

The upper parts 121a′, 121b′ of the first and second support posts 141 are formed from the same multi-layered film as the body 117, wherein the multi-layered film has a metallic layer 128 formed from a metallic material such as aluminum (Al), and first and second insulation layers 127, 129, such as silicon nitride films, deposited on the top and bottom sides of the metallic layer 128, respectively.

The first and second springs 122, 123 are respectively interposed between the rear and front edges 117c, 117d of the body 117 and the first and second support posts 121a, 121b. The first and second springs 122, 123 are formed from the same material as the metallic layers 128 of the body 117 of the switch pad 116 and the upper parts 121a′, 121b′ of the first and second support posts 121a, 121b, i.e., from a conductive metallic material such as aluminum (Al).

Although it has been exemplified and described above that the micro-switch is an RF switch 100 having first and second terminal connection units 130a, 130b, which come into contact with or move away from the first and second switching terminals 132b; 133a, 133b of the first and second signal lines 132, 133 to interconnect or cut off the first and second switching terminals 132b; 133a, 133b, the invention is not limited to this. Rather, a micro-switch employing the inventive switch pad 116 may be configured as a different switch with the same principle and construction of the above-described exemplary embodiments, e.g., a capacitive RF switch (not shown) comprising a switch pad (not shown), of which the body is formed of conductive metal and connected to a ground without having the first and second terminal connection units, and first and/or second signal lines having first and second capacitors (not shown) instead of the first and second switch terminals 132b; 133a, 133b. In this event, the capacitive RF switch is arranged in such a manner that when the body of the switch pad comes into contact with or moves away from the first or second signal line 132; 133, signals are bypassed to the ground or passed through the first or second signal line 132; 133 depending on the change of the capacitance of the first and second capacitors provided on the first or second signal line 132; 133.

Now, the action of the RF switch employing the exemplary embodiment of the switch pad 116 is described in detail with reference to FIGS. 4 to 5B.

Firstly, if a voltage is applied to one of the first and second electrodes 113, 114, for example, to the second electrode 114, an electrostatic force is generated between the second electrode 114 and a part opposite to the second electrode 114 in the body 117 of the switch pad 116, and the second end 117b of the body 117 is downwardly drawn by the electrostatic force, as shown in FIG. 5B. As a result, the body 117 is tilted about the first and second springs 122, 123 like a seesaw against the rotational torsional rigidity of the first and second springs 122, 123. Therefore, the second terminal connection unit 130b of the body 117 comes into contact with the first and second switching terminals 133a, 133b of the corresponding second signal line 133, thereby interconnecting the first and second switching terminals 133a, 133b. As a result, the second signal line 133 is turned “ON,” whereby signals flow through the second signal line 133.

To the contrary, if the supply of voltage to the second electrode 114 of the second electrostatic driving unit 114 is blocked, the electrostatic force disappears between the second electrode 114 and the part opposite to the second electrode 114 in the body 117, whereby the second end 117b of the body 117 is lifted and returned to its original position by the elastic force of the first and second springs 122, 123. As a result, the second terminal connection unit 130b of the body 117 moves away from the first and second switching terminals 133a, 133b, thereby cutting off the first and second switching terminals 133a, 133b. As a result, the second signal line 133 is turned “OFF,” thereby blocking the signal flow.

As described above, because the exemplary embodiment of the switch pad and a microstructure employing the same have an arrangement, in which as being more adjacent to the opposite end portions from the central portion of the body of the switch pad, the body of the switch pad is more remotely spaced from the horizontal plane containing the first and second driving electrodes installed on the substrate, the driving voltage applied to the first and second driving electrodes can be greatly reduced as compared with an RF switch having a conventional switch pad shaped in the straight flat form. Therefore, even if a driving voltage equal to or lower than that applied to the conventional RF switch by a predetermined range is applied to the first and second driving electrodes, the electrostatic force produced between the inventive switch pad and the first and second driving electrodes can be increased as compared with the conventional RF switch. Therefore, it is not necessary to reduce the rotational torsional rigidity of the first and second springs so as to stably drive the body of the switch pad. Furthermore, it is also possible to avoid the problem that the first and second springs become sensitive to a vibration environment due to the reduction of the rotational torsional rigidity of the first and second springs.

Although representative embodiments of the present invention have been shown and described in order to exemplify the principle of the present invention, the present invention is not limited to the specific exemplary embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. A switch pad for a micro-switch, which comes into contact with or moves away from a signal line to switch signal flow, the switch pad comprising:
a body having a central position supported above a substrate;
wherein, as approaching opposite end portions from the central portion of the body, the body becomes more remotely spaced from a horizontal plane containing a top surface of an electrostatic driving unit disposed on the substrate.

2. A switch pad as claimed in claim 1, wherein the body has a step-like shape.

3. A switch pad as claimed in claim 2, wherein the body has a curved shape.

4. A micro-switch comprising:
a substrate;
at least one signal line provided on the substrate;
at least one electrostatic driving unit provided on the substrate;
a switch pad, which comes into contact with or moves away from the signal line to switch signal flow, wherein the switch pad comprises a body formed so that as approaching opposite end portions from a central portion of the body, the body is more remotely spaced from a horizontal plane containing a top surface of the electrostatic driving unit; and
a spring structure which pivotally supports the switch pad at a central portion thereof above the substrate.

5. A micro-switch as claimed in claim 4, wherein the body has a step-like shape.

6. A micro-switch as claimed in claim 4, wherein the body has a curved shape.

7. A micro-switch comprising:
a substrate comprising a signal portion;
a switch pad; and
a connector disposed on the switch pad;
wherein the switch is selectively driven to selectively engage the connector with the signal portion; and
wherein a distance from the substrate to the switch pad varies over an area of the switch pad.

8. A micro-switch according to claim 7 wherein the connector is disposed on the switch pad at a connector portion; and
wherein a distance between substrate and the connector portion of the switch pad is greater than a distance between the substrate and another portion of the switch pad.

9. A micro-switch according to claim 7, wherein the substrate includes electrodes.

10. A micro-switch according to claim 9, wherein the switch is selectively driven by a selectively driving the electrodes to produce a force between the substrate and the switch pad.

11. A micro-switch according to claim 7, wherein the switch pad is step-shaped.

12. A micro-switch according to claim 7, wherein the switch pad is curved.

13. A micro-switch according to claim 7, wherein the distance between substrate and the connector portion of the switch pad is greater than a distance between the substrate and a portion of the switch pad connected to the substrate.
